(19) United States
(12) Patent Application Publication
(10) Pub. No.: US 2022/0359959 A1
(43) Pub. Date: Nov. 10, 2022

(54) LITHIUM ION RECHARGEABLE ELECTROCHEMICAL CELLS WITH INSULATED TABS AND METHODS OF FORMING THE SAME

(71) Applicant: GM GLOBAL TECHNOLOGY OPERATIONS LLC, Detroit, MI (US)

(72) Inventors: Sherman H. ZENG, Troy, MI (US); Youngnam KIM, Troy, MI (US); Christopher SCHLAUPITZ, White Lake, MI (US); Xingcheng XIAO, Troy, MI (US)

(73) Assignee: GM GLOBAL TECHNOLOGY OPERATIONS LLC, Detroit, MI (US)

(21) Appl. No.: 17/316,587

(22) Filed: May 10, 2021

(51) Int. Cl. H01M 50/536; H01M 10/0525; H01M 10/04

(52) U.S. Cl. CPC H01M 50/536; H01M 10/0525; H01M 10/04; H01M 2220/20

(57) ABSTRACT

A lithium-ion electrochemical cell assembly includes a first electrode having a first polarity and a first current collector defining a first electrically conductive tab at an edge of the first electrode. The first electrically conductive tab is substantially covered by a first insulation material. A second electrode has the first polarity and a second current collector defining a second electrically conductive tab at an edge of the second electrode. The second electrically conductive tab is substantially covered by a second insulation material. A weld nugget is formed through at least a portion of the first insulation material and the second insulation material that joins the first electrically conductive tab to the second electrically conductive tab together. Methods of forming lithium-ion electrochemical cells are also provided.

### INTRODUCTION

This section provides background information related to the present disclosure which is not necessarily prior art.

The present disclosure relates to lithium-ion electrochemical cells having electrodes with fully electrically isolated and electrically conductive tabs to minimize or prevent shorting and enhance electrochemical cell performance.

Electrochemical cells, such as lithium-ion batteries, can be used in a variety of consumer products and vehicles, such as hybrid or electric vehicles. Typical lithium-ion batteries comprise at least one positive electrode or cathode, at least one negative electrode or an anode, an electrolyte material, and an optionally separator. A stack of lithium-ion battery cells may be electrically connected in an electrochemical device to increase overall output. Lithium-ion batteries operate by reversibly passing lithium ions between the negative electrode and the positive electrode. A separator and/or electrolyte are disposed between the negative and positive electrodes. The electrolyte is suitable for conducting lithium ions and may be in solid, liquid, or gel form. Lithium ions move from a cathode (positive electrode) to an anode (negative electrode) during charging of the battery, and in the opposite direction when discharging the battery.

In a stack, each of the negative and positive electrodes may be electronically connected to a current collector (typically a metal, such as copper foil for the anode and aluminum foil for the cathode). The electrode active material may be disposed on the metal current collector foil by processes such as coating, lamination, or adhesion. Each current collector has at least one tab region, which is part of or integral with the current collector and that is made by processes such as cutting, notching or stamping, in a stack of electrochemical cells, can be joined with other tab regions via a joining process, like welding. During battery usage, the welded tabs associated with the current collectors of positive and negative electrodes, respectively, may be connected via an external circuit that allows current generated by electrons to pass between the electrodes to compensate for transport of lithium ions. For example, during cell discharge, the internal Li⁺ ionic current from the negative electrode to the positive electrode may be compensated by the electronic current flowing through the external circuit from the negative electrode to the positive electrode of the battery cell.

To prevent an unintentional shorts caused by contact between metal tabs or terminals where contact could cause an internal short, parts of each metal current collector, tab, or terminal should not be in direct contact each other, for example, the electrode active material may be insulated. For example, an insulation tape may be attached to the corresponding part, such as the bare surfaces of the current collector, for example in the tab region.

To avoid short circuits between tabs of different current collectors, insulating materials may be applied to one or more regions. Insulation currently is only applied to the positive or cathode electrode and tends to be applied only at a minimal height on the tab region of the current collector. The negative or anode tab is typically fully uncoated and has no insulation. Thus, the uncovered area of the electrically conductive current collector above the electroactive electrode material, but below a welding area where the tabs are joined, can be at potential risk for either a hard short or soft short or both to another polarity electrode. Further, the foil materials forming the current collectors and/or tabs may be delicate and bent during assembly. Any unintentional folding can create a source of short circuiting, especially when the tab has uncoated regions. Such shorting behavior is variable and unpredictable between different battery designs. It would be desirable to minimize such manufacturing variability and reduce any potential for shorting.

### SUMMARY

This section provides a general summary of the disclosure, and is not a comprehensive disclosure of its full scope or all of its features.

The present disclosure relates to lithium ion rechargeable electrochemical cells with insulated tabs and methods of forming the same.

In certain variations, the present disclosure pertains to a lithium-ion electrochemical cell assembly including a first electrode having a first polarity and a first current collector defining a first electrically conductive tab at an edge of the first electrode. The first electrically conductive tab is substantially covered by a first insulation material. The lithium-ion electrochemical cell assembly further includes a second electrode having the first polarity and having a second current collector defining a second electrically conductive tab at an edge of the second electrode. The second electrically conductive tab is substantially covered by a second insulation material. A weld nugget is formed through at least a portion of the first insulation material and the second insulation material that joins the first electrically conductive tab to the second electrically conductive tab together.

In certain aspects, the lithium-ion electrochemical cell assembly further includes a first electrical conduit in electrical communication with the weld nugget and the joined first and second electrically conductive tabs.

In certain aspects, the lithium-ion electrochemical cell assembly further includes an additional third insulation material disposed over exposed surfaces of the weld nugget.

In certain aspects, the edge of the first electrode defines a terminal region coated by the first insulation material and the edge of the second electrode defines a terminal region coated by the second insulation material.

In certain aspects, the lithium-ion electrochemical cell assembly further includes a third electrode having a second polarity and a third current collector defining a third electrically conductive tab formed on the third electrode. The third electrically conductive tab is substantially covered by a third insulation material. In certain aspects, the lithium-ion electrochemical cell assembly further includes a fourth electrode having the second polarity and having a fourth current collector defining a fourth electrically conductive tab disposed on at an edge of the fourth electrode. The fourth electrically conductive tab is substantially covered by a fourth insulation material, wherein the weld nugget is a first weld nugget. A second weld nugget is formed through the third insulation material and the fourth insulation material that joins the third electrically conductive tab to the fourth electrically conductive tab.

In certain aspects, the first and second insulation materials are selected from the group consisting of: aluminas, silicas, lithiated zeolites, fluorine-based polymers, polyvinylidene fluoride (PVdF), polyvinyl alcohol (PVA), sodium carboxymethyl cellulose, styrene butadiene rubber, polyacrylonitrile, polyimide, and combinations thereof.

In certain other variations, the present disclosure pertains to a lithium-ion electrochemical cell assembly including a first electrode having a first polarity and a first current collector defining a first electrically conductive tab at an of the first electrode. The first electrically conductive tab is substantially covered by a first insulation material including a lithiated zeolite. A second electrode having the first polarity and having a second current collector defines a second electrically conductive tab at an edge of the second electrode. The second electrically conductive tab is substantially covered by a second insulation material including a lithiated zeolite. A weld nugget is formed through at least a portion of the first insulation material and the second insulation material that joins the first electrically conductive tab to the second electrically conductive tab together.

In certain aspects, a first electrical conduit is in electrical connection with the weld nugget and the joined first and second electrically conductive tabs.

In certain aspects, the lithium-ion electrochemical cell assembly further includes a third electrode having a second polarity and a third current collector defining a third electrically conductive tab formed on the third electrode. The third electrically conductive tab is substantially covered by a third insulation material. A fourth electrode having the second polarity and having a fourth current collector defines a fourth electrically conductive tab disposed on at an edge of the fourth electrode. The fourth electrically conductive tab is substantially covered by a fourth insulation material, wherein the weld nugget is a first weld nugget. A second weld nugget is formed through the third insulation material and the fourth insulation material that joins the third electrically conductive tab to the fourth electrically conductive tab.

In yet other variations, the present disclosure pertains to methods of making a lithium-ion electrochemical cell assembly. In one aspect, the method includes welding a first electrically conductive tab of a first electrode covered by a first insulation material to a second electrically conductive tab of a second electrode covered by a second insulation material. The welding occurs through at least a portion of the first insulation material and the second insulation material to form a weld nugget.

In certain aspects, the welding is a laser welding process or a resistive welding process.

In certain aspects, the method further includes prior to the welding, applying the first insulation material to at least a portion of a first terminal edge of a first current collector adjacent to a central region having a first electroactive material disposed thereon of the first electrode. Further, the second insulation material is applied to at least a portion of a second terminal edge of a second current collector adjacent to a central region having a second electroactive material disposed thereon of the second electrode.

In certain further aspects, the method further includes removing a portion of the first terminal edge to define the first electrically conductive tab having the first insulation material disposed thereon. The method further includes removing a portion of the second terminal edge to define the second electrically conductive tab having the second insulation material disposed thereon.

In certain further aspects, the removing of the portion of the first terminal edge leaves a portion of the first insulation material remaining on the first terminal edge and the removing the portion of the second terminal edge leaves a portion of the second insulation material remaining on the second terminal edge.

In certain aspects, the applying the first insulation material includes applying a first slurry including a binder material and a plurality of electrically insulating particles and removing liquids from the first slurry to form the first insulation material. The method further includes applying the second insulation material includes applying a second slurry including a binder material and a plurality of electrically insulating particles and removing liquids from the second slurry to form the second insulation material.

In certain further aspects, the first slurry is applied to the first terminal edge of the first current collector during a coating process of the first electroactive material on the first current collector. The second slurry is applied to the second terminal edge of the second current collector during a coating process of the second electroactive material on the second current collector.

In certain further aspects, the first slurry is applied to the first terminal edge of the first current collector after a coating process of the first electroactive material on the first current collector. The second slurry is applied to the second terminal edge of the second current collector after a coating process of the second electroactive material on the second current collector.

In certain aspects, the first slurry is applied to the terminal edge of the first current collector during a coating process of the first electroactive material on the first current collector. The second slurry is applied to the terminal edge of the second current collector during a coating process of the second electroactive material on the second current collector.

In certain further aspects, the applying of the first insulation material occurs by immersing the first terminal edge in a slurry bath and drying it to form the first insulation material. The applying of the second insulation material occurs by immersing the second terminal edge in a slurry bath and drying it to form the second insulation material.

In certain further aspects, after the welding, the method further includes applying a third insulation material over exposed surfaces of the weld nugget.

In certain aspects, the method further includes prior to the welding: removing a portion of a first terminal edge of a first current collector to define the first electrically conductive tab and removing a portion of a second terminal edge of a second current collector to define the second electrically conductive tab. A first insulation material may then be applied to the first electrically conductive tab and a second insulation material may be applied to the second electrically conductive tab.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows an example of a rechargeable lithium ion electrochemical cell with a plurality of electrodes.

FIG. 2A shows a front view of an electrode having an upper region of an electrically conductive tab that is uncovered with an insulating material.

FIG. 2B is a sectional view of the electrode taken along line B-B′ of FIG. 2A.

FIG. 3A shows a front view of an electrode having a terminal region and electrically conductive tab coated in an insulating material through which a weld nugget is formed in accordance with certain aspects of the present disclosure.

FIG. 3B is a sectional view of the electrode taken along line B-B′ of FIG. 3A.

FIG. 4A shows a front view of an electrode having an electrically conductive tab coated in an insulating material through which a weld nugget is formed in accordance with certain aspects of the present disclosure.

FIG. 4B is a sectional view of the electrode taken along line B-B′ of FIG. 4A.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to electrochemical cells that may be used in, for example, automotive or other vehicles (e.g., motorcycles, boats), but may also be used in electrochemical cells used in a variety of other industries and applications, such as consumer electronic devices, by way of non-limiting example.

Generally, an electrochemical cell can refer to a unit that can be connected to other units. A plurality of electrically connected cells, for example, those that are stacked together, may be considered to be a module. A pack generally refers to a plurality of operatively-connected modules, which may be electrically connected in various combinations of series or parallel connections. The battery module may thus be encased in a pouch structure, a housing, or located with a plurality of other battery modules to form a battery pack. In certain aspects, the battery module may be part of a prismatic hybrid cell battery.

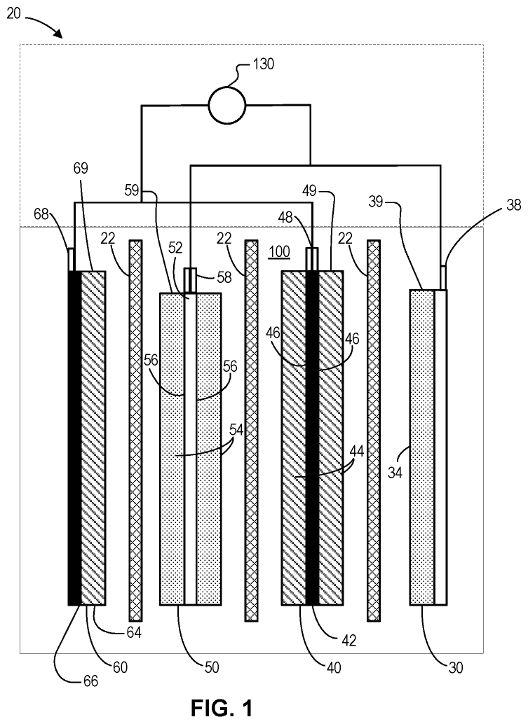

An exemplary and schematic illustration of a lithium-ion electrochemical cell (e.g. battery) 20 is shown in FIG. 1. As will be appreciated by those of skill in the art, the respective components will be compressed together without spacing in between when assembled. Further, while each cell unit may be defined between a positive and negative electrode, respectively, the plurality of unit cells form a battery that may be a stack of unit cells. In various aspects, the embodiments shown are representative, but not necessarily limiting, of battery configurations prepared in accordance with the present teachings and may apply to various other electrochemical devices and structures. The battery 20 may include at least two positive electrodes 30, 50 and at least two negative electrodes 40, 60. The battery 20 may further include an electrolyte 100. The electrolyte 100 may be a solid state electrolyte or may be a liquid or gel, in which case, separator components 22 as shown in FIG. 1 are disposed between respective positive and negative electrodes.

A first positive electrode 30 may be parallel with a second positive electrode 50 and a first negative electrode 40 may be disposed therebetween, with separators 22 disposed between each opposing positive and negative electrode. A second negative electrode 60 may be parallel with a side or surface of the second positive electrode 50 that opposes the negative electrode 40. In certain aspects, as shown, the positive and negative electrodes 30, 40, 50, 60 may be disposed within a single battery housing 110 containing an electrolyte 100. The skilled artisan will appreciate, however, that in various other aspects, other housing systems or designs may be present. Further, the first positive electrode 30 and the second positive electrode 50 may have the same of different compositions, while the first negative electrode 40 and second negative electrode 60 may have the same or different compositions. Other variations may include capacitor-assisted batteries having capacitive electrodes disposed within the stack (not shown).

As noted above, any appropriate electrolyte 100, whether in solid, liquid, or gel form, capable of conducting lithium ions between the electrodes 30, 40, 50, 60 may be used in the battery 20. In FIG. 1, the electrolyte 100 is a liquid or gel used with separators 22 disposed between electrodes of different polarities.

In various aspects, the first positive electrode 30 may include a first positive current collector 32 and one or more first positive electroactive material layers 34 disposed thereon. The one or more first positive electroactive material layers 34 may be disposed in electrical communication with the first positive current collector 32. The first positive current collector 32 further defines a tab 38 at a terminal edge 39. The tabs discussed herein, like tab 38, are electrically conductive and may be formed from the same material as a current collector, for example, a metal foil. In certain aspects, the tabs discussed herein are integrally formed with the current collector. The tabs may be coextensive with and extend along the entire length of the terminal edge 39 (corresponding to the electroactive active area) or may only be a portion of the length of the terminal edge 39 corresponding to the electrode active area. In such a variation, the tab may be formed by a notching or stamping processes of the current collector at the terminal edge 39. The first positive electroactive material layer 34 may be disposed at, on, or near a first surface 36 of the first positive current collector 32. The first positive electroactive material layer 34 of the first positive current collector 32 may face the negative electrode 40. The tab 38 extends beyond the terminal edge 39 and region coated with the first positive electroactive material layer 34.

In various aspects, the second positive electrode 50 may include a second positive current collector 52 and one or more second positive electroactive material layers 54 disposed on a portion thereof. The one or more second positive electroactive material layers 54 may be disposed in electrical communication with the second positive current collector 52. For example, the second positive electroactive material layer 54 may be disposed on, at, or near one or more parallel major surfaces 56 of the second positive current collector 52 (along opposite sides). In this manner, one major surface 56 of the second positive current collector 52 may face the negative electrode 40, while the other major surface 56 of the second positive current collector 52 may face the composite electrode 60. The second positive current collector 52 further defines at least one tab 58 that extends beyond a terminal edge 59 and thus beyond a region coated with the second positive electroactive material layer 54. The second positive electrode 50 may have a reduced length as compared to a length of the first negative electrode 40 and second negative electrode 60.

The current collectors may facilitate the flow of electrons between the positive electrodes and an exterior circuit. For example, an interruptible external circuit 120 and a load device 130 may connect the first positive electrode 30 (through the first positive current collector 32) and the second positive electrode 50 (through the second positive current collector 52).

The first and second positive current collectors 32, 52 may include metal, such as a metal foil, a metal grid or screen, or expanded metal. In certain aspects, the first and second positive current collectors 32, 52 may be a thin film or foil. A positive current collector may have a thickness of greater than or equal to about 1 micrometer (1 μm) to less than or equal to about 30 μm. The positive current collectors 32, 52 may be formed from aluminum, stainless steel and/or nickel or any other appropriate electrically conductive materials known to those of skill in the art. In various aspects, the first and second positive current collectors 32, 52 may be the same or different. The first positive electrode 30 may have a reduced length as compared to a length of the first negative electrode 40.

The one or more first positive electroactive material layers 34 and the one or more second positive electroactive material layers 54 may each comprise a lithium-based positive electroactive material that is capable of undergoing lithium intercalation and deintercalation, alloying and dealloying, or plating and stripping, while functioning as a positive terminal of the battery 20. To the extent not discussed herein in detail, examples of compositions and materials for forming various lithium-ion battery components, including positive electroactive materials, are described in U.S. Patent Publication No. 2021/0091424 to Gao et al., incorporated herein by reference in its entirety. In various aspects, the one or more first positive electroactive material layers 34 may comprise the same or different lithium-based positive electroactive material as the one or more second positive electroactive material layers 54. For example, each of the one or more first positive electroactive material layers 34 and the one or more second positive electroactive material layers 54 may be defined by a plurality of positive electroactive particles (not shown) comprising one or more transition metal cations, such as manganese (Mn), nickel (Ni), cobalt (Co), chromium (Cr), iron (Fe), vanadium (V), and combinations thereof. Independent pluralities of such positive electroactive particles may be disposed in layers to define the three-dimensional structures of the one or more first positive electroactive material layers 34 and the one or more second positive electroactive material layers 54. In certain variations, the one or more first positive electroactive material layers 34 and the one or more second positive electroactive material layers 54 may further include electrolyte 100, for example a plurality of electrolyte particles (not shown). In various aspects, the one or more first or second positive electroactive material layers 34, 54 may further include one or more electrically conductive materials that provide an electron conductive path and/or at least one polymeric binder material (that improves the structural integrity of the positive electrodes 30 or 50. The one or more first positive electroactive material layers 34 and/or the one or more second positive electroactive material layers 54 may each have a thickness greater than or equal to about 1 μm to less than or equal to about 1,000 μm in certain variations.

In various aspects, the first negative electrode 40 and second negative electrode 60 may respectively include a first negative current collector 42 and second negative current collector 62, as well as one or more first negative electroactive material layers 44 and one or more second negative electroactive material layers 64. The one or more first negative electroactive material layers 44 may be disposed in electrical communication with the first negative current collector 42. For example, the first negative electroactive material layer 44 may be disposed on, at, or near one or more parallel major surfaces 46 of the first negative current collector 42 (along opposite sides 46). In this manner, one major surface 46 of the first negative current collector 42 may face the first positive electrode 30 and the other major surface 46 of the first negative current collector 42 may face the second positive electrode 50. The first negative current collector 42 further defines at least one tab 48 at a terminal edge 49 that extends beyond the region coated with the first negative electroactive material layer 44.

Similarly, the second negative electroactive material layer 64 may be disposed in electrical communication with the second negative current collector 62. For example, the second negative electroactive material layer 64 may be disposed on, at, or near the major surface 66 of the second negative current collector 62. In this manner, one major surface 66 of the second negative current collector 62 may face the second positive electrode 50. The second negative current collector 62 further defines at least one tab 68 at a terminal edge 69 that extends beyond the region of the current collector 62 coated with the second negative electroactive material layer 64. The first and second negative current collectors 42, 62 may include metal, such as a metal foil, a metal grid or screen, or expanded metal. In certain aspects, the first and second negative current collectors 42, 62 may be a thin film or foil. A negative current collector may have a thickness of greater than or equal to about 1 μm to less than or equal to about 15 μm. The first and second negative current collectors 42, 62 may be formed from copper or any other appropriate electrochemically stable electrically conductive material known to those of skill in the art. The first negative electrode 40 and second negative electrode 60 may have a greater length as compared to a length of the first positive electrode 30 and second positive electrode 50.

For the first and second negative electrodes, 40, 60, the one or more first negative electroactive material layers 44 and the one or more second negative electroactive material layers 64 may each comprise a negative electroactive material that is a lithium host material that is capable for functioning as a negative terminal of the battery 20. In various aspects, the one or more first negative electroactive material layers 44 may comprise the same or different lithium-based negative electroactive material as the one or more second negative electroactive material layers 64. For example, each of the one or more first negative electroactive material layers 44 and the one or more second negative electroactive material layers 64 may include one or more negative electroactive materials selected from the group consisting of: graphite, graphene, lithium metal, lithium alloy, silicon (Si), silicon alloy, silicon oxide, activated carbon (AC), hard carbon (HC), soft carbon (SC), carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, the one or more first or second negative electroactive material layers 44, 64 may have a thickness greater than or equal to about 1 μm to less than or equal to about 1,000 μm. In various aspects, the one or more first or second negative electroactive material layers 44, 64 may further include electrolyte 100, for example a plurality of electrolyte particles or a liquid electrolyte (not shown); and optionally include one or more electrically conductive materials that provide an electron conductive path and/or at least one polymeric binder material (that improves the structural integrity of the negative electrode 40 or 60.

The negative electrode tab 48 is electrically connected to the internally disposed first negative current collector 42 and the first negative electroactive material layers 44 that together define the first negative electrode 40. Likewise, the negative electrode tab 68 is electrically connected to the internally disposed second negative current collector 62 and the second negative electroactive material layer 64 that in combination define the second negative electrode 60. The interruptible external circuit 120 and load device 130 may connect the first negative electrode 40 (through the first negative current collector 42) and the second negative electrode 60 (through the second negative current collector 62).

Thus, the positive electrode tab 38 is electrically connected to the internally disposed first positive current collector 32 and the first positive electroactive material layer 34 that together define the first positive electrode 30. The positive electrode tab 58 is electrically connected to the internally disposed second positive current collector 52 and the second positive electroactive material layer 54 that together define the second positive electrode 50. The positive electrodes 30, 50 and negative electrodes 40, 60 are electrically isolated from one another by the porous separator 22. As shown, each separator 22 extends beyond terminal ends of the tabs 38, 48, 58, and 68 to provide electrical insulation between tabs of opposite polarities.

Further, the positive tabs 38, 58 can be aligned and joined together, for example, by welding to form a single positive assembled tab that can be connected to a positive electrical conduit. The negative tabs 48, 68 can be aligned and joined together, for example, by welding to form a single negative assembled tab that can be connected to a negative electrical conduit.

After the common positive tabs are welded together, they can be appropriately capped or sheathed to form a plurality of positive electrical connectors. The positive electrical connectors may be connected to other electrical conduits with the same polarity, such as bus bars, circuitry, or may themselves form terminals for external connection to a load and power source. For example, certain examples of formation of the electrical connectors may include using a one-step ultrasonic welding to weld the electrode tab foil with external terminals (e.g., outside tabs for forming the final cell). Alternatively, ultrasonic welding can be first used to weld the electrode tab foil, and then use ultrasonic welding to weld foil with external terminals. In another example, ultrasonic welding can be used to weld the electrode tab foil first, and then laser and/or resistance welding can be used to weld foil with external terminals. In certain aspects, an external terminal material for a positive electrode comprises aluminum, by way of example.

Similarly, after the common negative tabs are welded together, they may be appropriately capped or sheathed to form a plurality of negative electrical connectors. The negative electrical connectors may be connected to other electrical conduits with the same polarity, such as bus bars, circuitry, or may themselves form terminals for external connection to loads, generators, or power sources and the like in the same manner as described above in the context of the positive electrical connector. In certain aspects, an external terminal material for a negative electrode comprises aluminum, copper, nickel, and nickel-coated copper, by way of example. The lithium-ion electrochemical cell assembly can be incorporated into other components, such as a housing or pouch.

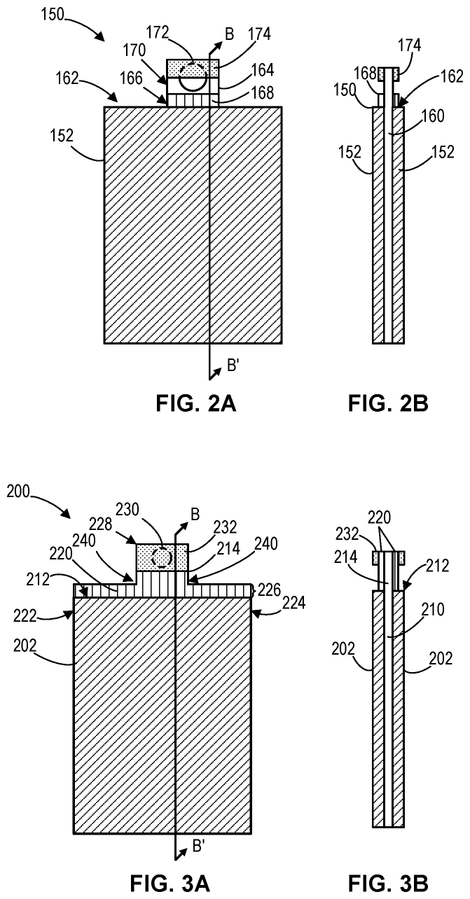

By way of background, in current manufacturing processes, the tabs of electrodes that are joined together via welding are often bare and then later covered with an electrically insulating material. In other processes, a portion of the tab is left bare for the welding process and later a portion of the tab may have an insulation material disposed thereon. FIGS. 2A-2B show a conventional design of a bilayer electrode 150 having active material layers formed on two sides of a current collector. FIG. 2A is a front view of the electrode 150, while FIG. 2B shows a side view of the electrode 150. The electrode 150 has a first electroactive material 152 disposed on two sides of a current collector 160. The current collector 160 extends beyond a terminal edge 162 of the electrode 150 to define a first electrically conductive tab 164. In the design shown, a lower region 166 of the tab 164 may have a first electrically insulating material 168 disposed thereon. However, an upper region 170 of tab 164 is left uncoated and is bare metal (depending on which metal the current collector 160 is made from). In current processes, the uncoated upper region 170 is welded to other tabs of other electrode layers in the assembly. The upper region 172 of the tab is left uncoated for the welding process. Thus, a weld nugget 172 is formed in the uncoated upper region 170. After the welding, at least a portion (shown) or all of the weld nugget 172 that is exposed is covered with a second electrically insulating material 174, like an electrically insulating tape.

During this process, often a gap of uncoated current collector 160 in the tab 164 remains between the first electrically insulating material 168 and the second insulating material 174. This uncoated region provides an opportunity for an electrical short to occur if tabs become misaligned during assembly and happen to be in near proximity to or contact other electrically conductive components of different polarities or the electroactive materials themselves.

Moreover, it has been observed that current collector materials, including the tabs formed at the terminal end, are often made of a thin layer of flexible or malleable material. Thus, during the manufacturing and assembly process, these materials are susceptible to unpredictable folding and wrinkling that may provide the potential for a soft or hard electrical short to occur when assembled with other components in the electrochemical cell assembly. Further, when used in vehicle applications, the electrochemical cell may be subjected to vibration and mechanical forces causing shifting, bending, and the like. In variations where the electrically conductive tabs are entirely uncoated or may have some uncoated regions (before or after welding), the tabs have been observed to occasionally create undesirable contact with other components and lead to potential shorting and failure of the cell or diminished performance. Further, in certain current designs, the separator serves as the only electrical insulation between the negative and positive electrodes. The separator typically overhangs the edge of negative and positive electrodes (where a length of the positive electrode is shorter than a length of the negative electrode), but the separator does not cover the tab area. This increases the risk of shorting between the negative and positive electrodes, if the separator fails due to misalignment, thermal shrinking, folding, and wrinkle during assembling.

The present technology thus modifies the manufacturing process to enhance surface coverage of tabs with electrically insulating materials, for example prior to welding, while still forming high quality weld nuggets through the electrically insulating materials. Moreover, in certain variations, the electrically insulating material used on the tabs not only provides electrical resistance, but also may enhance performance of the electrochemical cell in being formed of specialized insulating materials, as will be described further below. The present technology can further reduce potential issues with the separator being misaligned or shifting/shrinking during operation of the battery, where its ability to provide electrical isolation potentially is diminished.

FIGS. 3A-3B show a design of a bilayer electrode 200 according to certain aspects of the present disclosure. Notably, the concepts described herein are equally applicable to single sided electrodes. The electrode 200 has an electroactive material 202 disposed on two sides of a current collector 210. The current collector 210 extends beyond a terminal edge 212 of the electrode 200 to define an electrically conductive tab 214. Notably, the tab 214 is not limited to the design shown in FIGS. 3A-3B and may be in a different location or there may be multiple tabs, for example, disposed on other edges.

For the tabs discussed herein, like tab 214, it may be rectangular in shape and thus have a width and height. In certain variations, a tab may have a width that is equal to an overall width of the entire terminal edge of the negative or positive current collector in the electrode region (where the electroactive material layer is disposed). In other variations, each tab has a width that may occupy less than half of the length of each terminal edge of the electrode, for example, a tab width may be greater than or equal to about 15% to less than or equal to about 45% of an overall length of each respective edge. In certain aspects, a height of the tab may be greater than or equal to about 5 mm to less than or equal to about 30 mm. In certain other aspects, a width of the tab may be greater than or equal to about 30 mm to less than or equal to about 300 mm.

In the design shown, the tab 214 may have a first electrically insulating material 220 disposed thereon. Notably, the first electrically insulating material 220 coats not only the electrically conductive tab 214, but also is coextensive with and extends along the terminal edge 212 from a first side 222 of the electrode 200 to a second side 224 of the electrode 200 to define a lateral strip 226 of insulating material, as best shown in FIG. 3A.

In certain variations, the electrically insulating material 220 may substantially coat the exposed surfaces of tab 214. By substantially coat or cover, it is meant that the first electrically insulating material 220 may cover greater than or equal to about 90% of the exposed surface area of the tab 214, optionally greater than or equal to about 92% of the exposed surface area, optionally greater than or equal to about 95% of the exposed surface area, optionally greater than or equal to about 97% of the exposed surface area, optionally greater than or equal to about 98% of the exposed surface area, optionally greater than or equal to about 99% of the exposed surface area, and in certain aspects, 100% of the exposed surface area of the tab 214. Notably, the first electrically insulating material 220 extends from the terminal edge 212 of the body of the electrode 200 to an upper edge 228 of the tab 214. In this variation, the presence of the lateral strip 226 along the terminal edge 212 provides an additional measure of protection from possible shorting, but shielding and electrically insulating corner regions 240 defined between the thermal edge 212 and the tab 214. If the lateral strip 226 was absent, there might be the potential for electrical current from the tab 214 passing through the shoulders 240 and contacting the electroactive material 202.

The coated tab 214 may then be welded to other tabs of other electrode layers in the assembly to form a weld nugget 230. As will be discussed in greater detail below, the selection of the insulating material in combination with the type of welding process selected can ensure that the weld nugget 230 establishes required electrical conductivity, while providing enhanced protection from inadvertent folding or wrinkling of materials. After the weld nugget 230 is formed, at least a portion or all of the exposed surfaces of the weld nugget 230 are coated with a second electrically insulating material 232, like an electrically insulating tape.

In an alternative variation not shown, an upper region of the tab 214 near upper edge 228 may be uncoated for the welding process, so that the weld nugget 230 is only partially formed through a portion of the electrically insulating material 220. In this variation, the tab 214 may only be partially covered by the insulating material, for example, covering greater than or equal to about 50% of the exposed surface area of the tab 214, optionally greater than or equal to about 60% of the exposed surface area, optionally greater than or equal to about 75% of the exposed surface area, optionally greater than or equal to about 80% of the exposed surface area, optionally greater than or equal to about 85% of the exposed surface area, optionally greater than or equal to about 90% of the exposed surface area of the tab 214. After welding, the upper region may then be coated with the second electrically conductive material 232. It should be noted that such a variation may be less advantageous than the one described above with substantially all of the exposed surface of the tab 214 being covered, because potential shorting issues with the exposed electrically conductive surfaces may still cause issues if they occur prior to welding. Notably, together the first electrically insulating material 220 and the second electrically insulating material 232 extends from the terminal edge 212 of the body of the electrode 200 to an upper edge 228 of the tab 214 to provide full insulating coverage after welding.

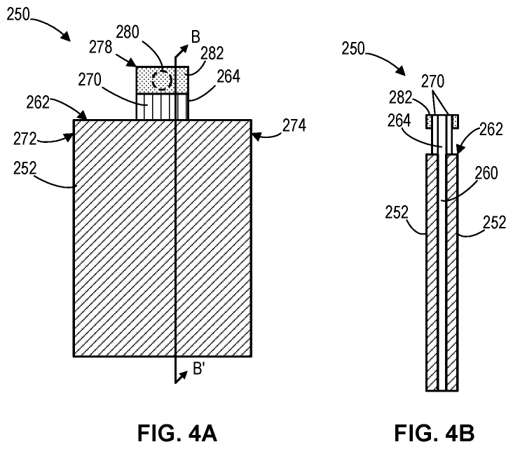

FIGS. 4A-4B show a design of a bilayer electrode 250 according to certain aspects of the present disclosure. The electrode 250 has an electroactive material 252 disposed on two sides of a current collector 260. The current collector 260 extends beyond a terminal edge 262 of the electrode 250 to define an electrically conductive tab 264. As with other variations, the tab 264 placement and number are not limited to the design shown. The tab 264 may have a first electrically insulating material 270 disposed thereon. Notably, in this embodiment, the first electrically insulating material 270 coats only the electrically conductive tab 264, but is not coextensive with and therefore does not extend along the terminal edge 262 from a first side 272 of the electrode 250 to a second side 274 of the electrode 250. In this variation, less of the first electrically insulating material 270 is used.

In certain variations, the electrically insulating material 270 may substantially coat the exposed surfaces of tab 264 as described previously above. The first electrically insulating material 270 extends from the terminal edge 262 of the body of the electrode 250 to an upper edge 278 of the tab 264.

The coated tab 214 may then be welded to other tabs of other electrode layers in the assembly to form a weld nugget 280. At least a portion or all of the exposed surfaces of the weld nugget 280 are coated with a second electrically insulating material 282, like an electrically insulating tape. The first electrically insulating material 270 and the second electrically insulating material 282 extend from the terminal edge 262 of the body of the electrode 250 to the upper edge 278 of the tab 264 to provide full insulating coverage after welding.

In an alternative variation not shown, an upper region of the tab 264 near upper edge 278 may be uncoated for the welding process, so that the weld nugget 280 is only partially formed through a portion of the electrically insulating material 270. In this variation, the tab 264 may only be partially covered by the insulating material as described previously above. After welding, the upper region may then be coated with the second electrically conductive material 282.

In various aspects, the present disclosure thus provides a lithium-ion electrochemical cell assembly that comprises a first electrode that has a first polarity and a second electrode that has the same polarity as the first electrode. For example, the first electrode and second electrode may both be negative electrodes or alternative positive electrodes. The first electrode has a first current collector defining a first electrically conductive tab at an edge of the first electrode. The first electrically conductive tab is substantially covered by a first insulation material. The second electrode defines a second electrically conductive tab at an edge of the second electrode, where the second electrically conductive tab is substantially covered by a second insulation material. The first and second insulation materials may have the same composition or may differ from one another. A weld nugget is formed through at least a portion of the first insulation material and the second insulation material that joins the first electrically conductive tab to the second electrically conductive tab together

In certain aspects, the lithium-ion electrochemical cell assembly further comprises a first electrical conduit in electrical connection with the weld nugget and the joined first and second electrically conductive tabs. An electrical connection between the external conduit to respective tabs can be formed by any of the following processes: ultrasonic welding, laser welding, resistance spot welding, or a mechanical connection through a bolt or a nugget. Thus, in certain variations, an external conduit may be welded to the weld nugget. For example, an external weld is usually over welded through the first weld nugget, which welds all tabs together.

In certain variations, an additional third insulation material disposed over exposed surfaces of the weld nugget. In various aspects, the electrically insulating materials described herein, including the first, second, and third electrically insulating materials may have common properties. The insulation materials may have a resistance of greater than or equal to about 10 MΩ to less than or equal to about 10⁶ MΩ, optionally greater than or equal to about 100 MΩ to less than or equal to about 10⁶ MΩ, optionally greater than or equal to about 250 MΩ to less than or equal to about 10⁶ MΩ, or optionally greater than or equal to about 500 MΩ to less than or equal to about 10⁶ MΩ, at standard temperature conditions.

In certain aspects, the insulation materials may be an insulating ceramic material or an insulating polymeric material. In certain variations, the insulating material may be a ceramic-type material selected from the group consisting of: aluminas (Al₂O₃), silicas (SiOx, such as silicon dioxide (SiO₂)), phosphates, zeolites (containing both aluminas (Al₂O₃) silicas (SiOx)), and combinations thereof.

In other aspects, the insulating material may be a polymeric material selected from the group consisting of: vinyl based polymers, such as polyvinyl alcohol (PVA), polyvinylchloride (PVC), and insulating fluorine-based polymers, such as poly(tetrafluoroethylene) (PTFE), polyvinylidene fluoride (PVdF), fluorinated ethylene propylene (FEP), polyperfluorocyclobutanes, polyvinylidene fluoride copolymers (e.g., PVdF-hexafluoropropylene or (PVdF-HFP)), and polyvinylidene fluoride terpolymers, polyvinylfluoride, water-soluble binder materials, such as styrene butadiene rubber, sodium carboxymethyl cellulose, styrene butadiene rubber and sodium carboxymethyl cellulose (SBR+CMC), polyacrylonitrile, polyimide, and combinations or copolymers thereof.

In certain variations, the insulation materials are selected from the group consisting of: aluminas, silicas, zeolites, fluorine-based polymers, such as polyvinylidene fluoride (PVdF), polyvinyl chloride (PVC), polyvinyl alcohol (PVA), sodium carboxymethyl cellulose, styrene butadiene rubber, polyacrylonitrile, polyimide, and combinations thereof.

The insulating material may also be a material that enhances the performance of the lithium-ion electrochemical cell assembly. As shown in FIG. 1, the tabs on the electrodes are exposed to and in contact with electrolyte. In certain variations, the electrically insulating material used to coat the surfaces of the tabs may serve to enhance the performance of the cell, for example, by scavenging undesirable species or enhancing availability or reducing consumption of lithium during cycling of the electrochemical cell(s). By way of example, such an active material may be a lithium ion-exchanged zeolite material. The term “lithium ion-exchanged zeolite material” means a zeolite that has been ion-exchanged with lithium ions such that a plurality of lithium ions are present within the zeolite as free ions and/or as extra-framework ions, such as those described in co-owned U.S. Pat. No. 10,950,836 to Xiao et al., which is incorporated herein by reference in its entirety.

In one variation, the insulating material may comprise a lithium ion-exchanged zeolite particle that may comprise or consist essentially of particles of one or more natural or synthetic zeolite materials. Zeolites are microporous crystalline aluminosilicate materials comprising a three-dimensional framework of AlO₂ and SiO₂ tetrahedral units and extra-framework cations. Each AlO₂ unit introduces one negative charge to the framework, which is offset by the extra-framework cations. The extra-framework cations may be organic or inorganic in nature. In various aspects, the lithium ion-exchanged zeolite particles may comprise a three-dimensional framework of AlO₂ and SiO₂ tetrahedral units and extra-framework lithium cations (Li⁺). The amount of extra-framework lithium cations present in the lithium ion-exchanged zeolite particles can at least partially depend on the Si:Al ratio of the specific zeolite material and the cation exchange capacity (CEC) of the zeolite material. In the lithium ion-exchanged zeolite particles, lithium cations (Li+) may comprise greater than or equal to about 90 atomic % (at. %), greater than or equal to about 95 at. %, greater than or equal to 99 at. %, or about 100 at. % of the extra-framework cations in the zeolite particles. In some embodiments, the zeolite may be in dehydrated form.

In some embodiments, the lithium ion-exchanged zeolite particles, for example, prior to operation in an electrochemical cell, may comprise less than or equal to about 10 at. %, less than or equal to about 5 at. %, or less than or equal to about 1 at. % of one or more of the following extra-framework cations: Na⁺, K⁺, Mg⁺, Ca⁺, and NH₄⁺. In some embodiments, the lithium ion-exchanged zeolite particles may comprise less than or equal about 1 at. % of one or more of H⁺ and NH₄⁺. In some embodiments, the lithium ion-exchanged zeolite particles may comprise one or more of H⁺ and NH₄⁺ in an amount greater than one or more of the following cations: Na⁺, K⁺, Mg⁺, and Ca⁺. Additionally or alternatively, the lithium ion-exchanged zeolite particles may be substantially free of one or more of: Na⁺, K⁺, Mg⁺, and Ca⁺ cations.

The crystal structures of zeolites include interstitial spaces (or cages) of molecular dimensions. As such, zeolites may be used as adsorbents to selectively adsorb molecules by retaining the molecules within their interstitial spaces. Access to the interstitial spaces within a zeolite is provided by pore openings (or channels) in the crystal lattice of the zeolite, which are defined by rings of interconnected oxygen (O), silicon (Si), and/or aluminum (Al) atoms. The size and shape of these pore openings limit the size and shape of the molecules that can be adsorbed by the zeolite and are determined, at least in part, by the number of tetrahedral units (or, alternatively, oxygen atoms) that make up the rings and by the type of extra-framework cations present within the zeolite. Thus, the lithium-exchanged zeolite particles may have an average pore size diameter capable of one or more of the following: (i) selectively absorbing water molecules (e.g., trace amounts) from the liquid electrolyte, without adsorbing the organic solvent molecules or the lithium salt ions in the electrolyte solution in the electrolyte. In some embodiments, the lithium ion-exchanged zeolite particles may have an average pore size diameter larger than the ionic radius of water (H₂O), but less than the ionic radius of the organic solvent molecules in the electrolyte solution. In particular, the lithium ion-exchanged zeolite particles may have an average pore size diameter of less than or equal to about 1.5 nm, less than or equal to about 1 nm, less than or equal to about 0.75 nm, less than or equal to about 0.5 nm, less than or equal to about 0.25 nm, less than or equal to about 0.1 nm, or about 0.01 nm. Additionally or alternatively, the lithium ion-exchanged zeolite particles may have an average pore size diameter of greater than or equal to about 0.01 nm to less than or equal to about 1.5 nm, greater than or equal to about 0.01 nm to less than or equal to about 1 nm, greater than or equal to about 0.1 nm to less than or equal to about 1 nm, or greater than or equal to about 0.25 nm to less than or equal to about 0.75 nm. Zeolite materials having pore openings with widths or diameters as described above may include zeolite materials having pore openings defined by 8-membered, 9-membered, 10-membered, and/or 12-membered rings.

Zeolite materials may be categorized based upon the crystalline structure of their corner-sharing network of tetrahedrally coordinated atoms or T-atoms (e.g., Si and Al). Zeolite structures are typically described or defined by reference to a framework type code consisting of three capital letters and assigned by the International Zeolite Association (“IZA”). A listing of all framework type codes assigned by the IZA can be found in the Atlas of Zeolite Framework Types, Sixth Revised Edition, Elsevier (2007).

In some embodiments, the lithium ion-exchanged zeolite particles may comprise particles of a zeolite material having a SiO₂:Al₂O₃ ratio of less than or equal to about 50, less than or equal to about 40, less than or equal to about 30, less than or equal to about 20, or about 10. The lithium ion-exchanged zeolite particles may comprise particles of a zeolite material having a SiO₂:Al₂O₃ ratio in the range of greater than or equal to about 10 to less than or equal to about 50, greater than or equal to about 10 to less than or equal to about 40, greater than or equal to about 10 to less than or equal to about 20, greater than or equal to about 20 to less than or equal to about 50, about 20 to about 40, or about 30 to about 50. In some embodiments, lithium ion-exchanged zeolite particles with more SiO₂ compared to Al₂O₃, for example, having a SiO₂:Al₂O₃ ratio greater than about 10, are preferred, for example, for increased stability. In other embodiments, lithium ion-exchanged zeolite particles with more Al₂O₃ compared to SiO₂, for example, having a SiO₂:Al₂O₃ ratio less than about 10, are preferred, for example, for an increased hydrofluoric acid (HF) scavenger function of the porous separator to protect the positive electrode.

The lithium ion-exchanged zeolite particles may comprise a zeolite material having a framework type selected from the group consisting of NAT, EDI, THO, ANA, YUG, GOO, MON, HEU, STI, BRE, FAU, MFI, LTL, LTA, and a combination thereof. For example, the lithium ion-exchanged zeolite particles may comprise a zeolite material selected from the group consisting of zeolite A, zeolite Y, zeolite L, ZSM-5, and a combination thereof.

The lithium ion-exchanged zeolite particles disposed on a tab as a coating material can be in contact with electrolyte. The lithium ion-exchanged zeolite particles may be formulated or selected, to adsorb, scavenge, entrap or otherwise inhibit the movement of certain target compounds within the electrochemical cell, without adversely affecting the transport or net flow of lithium ions through the electrochemical cell. For example, the particles of the lithium ion-exchanged zeolite particles may be formulated or selected based on the above-described pore size diameter, average particle size diameter, and/or cation content, to entrap or inhibit the movement of water molecules, polysulfide molecules, hydrogen ions, HF, and transition metal ions, such as Mn²⁺ and Fe^{2+/3+} ions, within the electrochemical cell 10. The target compounds may be entrapped within the lithium ion-exchanged zeolite particles either physically, chemically, or both physically and chemically.

As such, including the lithium ion-exchanged zeolite particles within the coating layer on the tabs of the electrodes can help prevent a phenomenon referred to as “voltage droop,” reduce capacity fade and impedance, improve Coulombic Efficiency, help maintain uniform current distribution along the electrode/electrolyte interface, reduce corrosion, and prevent outgassing of the cell.

In certain aspects, an insulation material may be a composite that includes a polymeric matrix or binder in which insulating particles are disposed. The polymeric matrix may be a fluorine-based polymer, polyvinyl chloride (PVC), polyvinyl alcohol (PVA), and combinations thereof. The insulating particles or powder may be an insulating ceramic, such as aluminas, silicas, zeolites, lithiated zeolites, and combinations thereof. In certain aspects, the insulation material may comprise greater than or equal to about 5% by weight to less than or equal to about 95% of the polymeric binder and greater than or equal to about 5% to less than or equal to about 95% of the insulating particles. Such insulating materials may be applied as a coating on the tab via a slurry casting process. In other variations, the insulating material may be a sheet, film, or tape material formed of a polymer, such as polyvinyl chloride, polyvinyl alcohol, or fluorine-based polymers, by way of example. Insulating tape materials may have a resistance of greater than or equal to about 100 MΩ to less than or equal to about 10⁶ MΩ. By way of non-limiting example, one suitable insulating tape material is sold by 3M as Scotch® Super Vinyl electrical tape. In certain aspects, a first insulation material applied to the tab prior to welding is an electrically insulative composite material comprising a polymeric matrix with insulating particles, while a second insulation material applied to the tab after welding may be an electrically insulative composite material or a tape, sheet, or film.

Depending on the properties of the specific materials, the thickness of the insulation coating may vary. However, generally the insulating materials may be applied at a thickness of greater than or equal to about 2 μm to less than or equal to about 100 μm.

In other variations, the edge of the first electrode defines a terminal region that is further coated by the first insulation material and the edge of the second electrode defines a terminal region that is likewise coated by the second insulation material.

The present disclosure also provides method of making a lithium-ion electrochemical cell assembly. In one variation, the method includes welding a first electrically conductive tab of a first electrode covered by a first insulation material to a second electrically conductive tab of a second electrode covered by a second insulation material. As will be appreciated by those of skill in the art, the methods are not limited to solely two electrodes, but rather may include fabricating many more electrodes for use in the electrochemical cell. The welding occurs through at least a portion of the first insulation material and the second insulation material to form a weld nugget.

The welding may be ultrasonic welding, laser welding or resistance welding. In certain aspects, the welding may be a laser welding or resistance spot welding process, as such processes help to increase temperatures and/or melt the metals to create a puddle that can penetrate through the insulation coatings. Generally, the objective is to form a weld nugget that does not decrease the electrical conductivity of tabs to an external conduit, while still insulating the tabs from the electrodes. The welding could diminish or damage the insulation layer, therefore a third insulation material or coating is applied after welding, for example, by adding a layer of insulation tape or dipping/immersing the welded tabs into an insulation material precursor so that a coating can be formed over the welded nugget.

In certain aspects, prior to the welding, the method may further include applying the first insulation material to at least a portion of a first terminal edge of a first current collector adjacent to a central region having a first electroactive material disposed thereon of the first electrode. The method may also further comprise applying the second insulation material to at least a portion of a second terminal edge of a second current collector adjacent to a central region having a second electroactive material disposed thereon of the second electrode.

In a further aspect, the method may include removing a portion of the first terminal edge to define the first electrically conductive tab having the first insulation material disposed thereon and removing a portion of the second terminal edge to define the second electrically conductive tab having the second insulation material disposed thereon. The removing process may be a cutting, notching, stamping, or etching process that removes portions of the respective current collectors to form the electrically conductive tabs.

In certain further aspects, the method further comprises applying the first insulation material by applying a first slurry comprising a binder material and a plurality of electrically insulating particles. The method also includes removing liquids from the slurry by drying to form the first insulation material. The second insulation material is also applied by applying a second slurry comprising a binder material and a plurality of electrically insulating particles and removing liquids from the slurry to form the second insulation material.

A slurry may be made by mixing particles, such as electrically insulating particles with a polymeric binder compound, a non-aqueous solvent, optionally a plasticizer, and optionally electrically conductive particles. The polymeric binder may be any of the electrically insulating polymers discussed above, including polyvinyl alcohol, polyvinyl chloride, and fluorine-containing polymers discussed above. Suitable non-aqueous aprotic organic solvents, include but are not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof. The slurry can be mixed or agitated, and then thinly applied to the substrate, for example via a doctor blade to a select region of the current collector. In one variation, heat or radiation can be applied to evaporate the solvent to leave a solid residue or insulating film/coating. It may be necessary to extract or remove any remaining plasticizer prior to incorporation into the battery cell.

In certain variations, the method may include applying the first slurry to the terminal edge of the first current collector during or concurrent to a coating process of the first electroactive material on the first current collector and coating the second slurry is applied to the terminal edge of the second current collector during or concurrent to a coating process of the second electroactive material on the second current collector. In this manner, the slurry for forming the insulating coating may be applied to the current collector at the same time that the slurry for forming the electrode active area is applied.

An electroactive area may be made by mixing particles including electroactive materials into a slurry with a polymeric binder compound, a non-aqueous solvent, optionally a plasticizer, and optionally electrically conductive particles. The slurry can be mixed or agitated, and then thinly applied to a substrate of the current collector, for example via a doctor blade. Again, heat or radiation can be applied to evaporate the solvent from the electrode film, leaving a solid residue. Notably, if both the insulating slurry and electroactive material slurry are applied at the same time, the application of heat, vacuum, or radiation may occur at the same time over the terminal end and/or tab region to form both the insulating material film and the electroactive film. The electrode film may be further consolidated, where heat and pressure are applied to the film to sinter and calendar it. In other variations, the film may be air-dried at moderate temperature to form self-supporting films. Again, it may be necessary to extract or remove any remaining plasticizer prior to incorporation into the battery cell.

In an alternative variation, the method may include applying the first slurry to the terminal edge of the first current collector after a coating process of the first electroactive material on the first current collector and coating the second slurry is applied to the terminal edge of the second current collector after a coating process of the second electroactive material on the second current collector. In this manner, the slurry for forming the insulating coating may be applied to the current collector after the electroactive material/electrode film has already been formed on the current collector.

In certain aspects, the method may include applying the first slurry to the terminal edge of the first current collector so that it is coextensive with the terminal edge during a coating process of the first electroactive material on the first current collector. The method may likewise also include applying the second slurry to the terminal edge of the second current collector so that it is coextensive with the terminal edge during a coating process of the second electroactive material on the second current collector.

In certain aspects, the applying of the first insulation material occurs by immersing the first terminal edge in a slurry bath and drying it to form the first insulation material and the applying of the second insulation material occurs by immersing the second terminal edge in a slurry bath and drying it to form the second insulation material.

In other aspects, the removing of the portion of the first terminal edge leaves a portion of the first insulation material remaining on the first terminal edge (such as is shown in FIGS. 3A-3B) and the removing the portion of the second terminal edge leaves a portion of the second insulation material remaining on the second terminal edge.

In other variations, the applying of the first insulation material and second insulation materials are only to a portion of a first terminal edge of a first current collector, namely only to the tab region, or a portion of second terminal edge of a second current collector (such as is shown in FIGS. 4A-4B). The tab may have been notched or cut prior to the applying. In this manner, less insulating material is used.

In yet another variation, the method further includes prior to the welding: removing a portion of a first terminal edge of a first current collector to define the first electrically conductive tab and removing a portion of a second terminal edge of a second current collector to define the second electrically conductive tab. A first insulation material may then be applied to the first electrically conductive tab and a second insulation material may be applied to the second electrically conductive tab.

After the welding of tabs together, the method may further comprise applying a third insulation material over exposed surfaces of the weld nugget. This may be done by applying a tape, film, or sheet over the exposed regions of the weld nugget or by applying the third insulating material as a slurry onto the welded tabs, for example, by dip coating the welded tabs in a slurry bath. In this manner, improved electrodes are formed that use insulation materials to cover the bare areas of the electrode tab area to prevent or minimize potential internal hard and soft shorting between two electrodes within the cell. This helps enhance the safety of battery cells and performance of battery system (e.g., minimizing voltage droop due to soft short from electrodes or cells). Each individual electrode can be fully electrically isolated, but employing an insulation material, e.g., tape or slurry coating, that can cover the entire bare foil area in the tab and terminal end regions of electrodes.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lithium-ion electrochemical cell assembly comprising:
a first electrode having a first polarity and a first current collector defining a first electrically conductive tab at an edge of the first electrode, wherein the first electrically conductive tab is substantially covered by a first insulation material;
a second electrode having the first polarity and having a second current collector defining a second electrically conductive tab at an edge of the second electrode, wherein the second electrically conductive tab is substantially covered by a second insulation material; and
a weld nugget formed through at least a portion of the first insulation material and the second insulation material that joins the first electrically conductive tab to the second electrically conductive tab together.

2. The lithium-ion electrochemical cell assembly of claim 1, further comprising a first electrical conduit in electrical communication with the weld nugget and the joined first and second electrically conductive tabs.

3. The lithium-ion electrochemical cell assembly of claim 1, further comprising an additional third insulation material disposed over exposed surfaces of the weld nugget.

4. The lithium-ion electrochemical cell assembly of claim 1, wherein the edge of the first electrode defines a terminal region coated by the first insulation material and the edge of the second electrode defines a terminal region coated by the second insulation material.

5. The lithium-ion electrochemical cell assembly of claim 1, further comprising:
a third electrode having a second polarity and a third current collector defining a third electrically conductive tab formed on the third electrode, wherein the third electrically conductive tab is substantially covered by a third insulation material; and
a fourth electrode having the second polarity and having a fourth current collector defining a fourth electrically conductive tab disposed on at an edge of the fourth electrode, wherein the fourth electrically conductive tab is substantially covered by a fourth insulation material, wherein the weld nugget is a first weld nugget, and
a second weld nugget is formed through the third insulation material and the fourth insulation material that joins the third electrically conductive tab to the fourth electrically conductive tab.

6. The lithium-ion electrochemical cell assembly of claim 1, wherein the first and second insulation materials are selected from the group consisting of: aluminas, silicas, lithiated zeolites, fluorine-based polymers, polyvinylidene fluoride (PVdF), polyvinyl alcohol (PVA), sodium carboxymethyl cellulose, styrene butadiene rubber, polyacrylonitrile, polyimide, and combinations thereof.

7. A lithium-ion electrochemical cell assembly comprising:
a first electrode having a first polarity and a first current collector defining a first electrically conductive tab at an of the first electrode, wherein the first electrically conductive tab is substantially covered by a first insulation material comprising a lithiated zeolite; and
a second electrode having the first polarity and having a second current collector defining a second electrically conductive tab at an edge of the second electrode, wherein the second electrically conductive tab is substantially covered by a second insulation material comprising a lithiated zeolite; and
a weld nugget formed through at least a portion of the first insulation material and the second insulation material that joins the first electrically conductive tab to the second electrically conductive tab together.

8. The lithium-ion electrochemical cell assembly of claim 7, wherein a first electrical conduit is in electrical connection with the weld nugget and the joined first and second electrically conductive tabs.

9. The lithium-ion electrochemical cell assembly of claim 7, further comprising:
a third electrode having a second polarity and a third current collector defining a third electrically conductive tab formed on the third electrode, wherein the third electrically conductive tab is substantially covered by a third insulation material; and
a fourth electrode having the second polarity and having a fourth current collector defining a fourth electrically conductive tab disposed on at an edge of the fourth electrode, wherein the fourth electrically conductive tab is substantially covered by a fourth insulation material, wherein the weld nugget is a first weld nugget, and
a second weld nugget is formed through the third insulation material and the fourth insulation material that joins the third electrically conductive tab to the fourth electrically conductive tab.

10. A method of making a lithium-ion electrochemical cell assembly comprising:
welding a first electrically conductive tab of a first electrode covered by a first insulation material to a second electrically conductive tab of a second electrode covered by a second insulation material, wherein the welding occurs through at least a portion of the first insulation material and the second insulation material to form a weld nugget.

11. The method of claim 10, wherein the welding is a laser welding process or a resistive welding process.

12. The method of claim 10, further comprising prior to the welding:
applying the first insulation material to at least a portion of a first terminal edge of a first current collector adjacent to a central region having a first electroactive material disposed thereon of the first electrode; and
applying the second insulation material to at least a portion of a second terminal edge of a second current collector adjacent to a central region having a second electroactive material disposed thereon of the second electrode.

13. The method of claim 12, further comprising:
removing a portion of the first terminal edge to define the first electrically conductive tab having the first insulation material disposed thereon; and
removing a portion of the second terminal edge to define the second electrically conductive tab having the second insulation material disposed thereon.

14. The method of claim 13, wherein the removing of the portion of the first terminal edge leaves a portion of the first insulation material remaining on the first terminal edge and the removing the portion of the second terminal edge leaves a portion of the second insulation material remaining on the second terminal edge.

15. The method of claim 12, wherein the applying the first insulation material comprises applying a first slurry comprising a binder material and a plurality of electrically insulating particles and removing liquids from the first slurry to form the first insulation material; and the applying the second insulation material comprises applying a second slurry comprising a binder material and a plurality of electrically insulating particles and removing liquids from the second slurry to form the second insulation material.

16. The method of claim 15, wherein:
(i) the first slurry is applied to the first terminal edge of the first current collector during a coating process of the first electroactive material on the first current collector; and
the second slurry is applied to the second terminal edge of the second current collector during a coating process of the second electroactive material on the second current collector; or
(ii) the first slurry is applied to the first terminal edge of the first current collector after a coating process of the first electroactive material on the first current collector; and
the second slurry is applied to the second terminal edge of the second current collector after a coating process of the second electroactive material on the second current collector.

17. The method of claim 15, wherein the first slurry is applied to the terminal edge of the first current collector during a coating process of the first electroactive material on the first current collector; and
the second slurry is applied to the terminal edge of the second current collector during a coating process of the second electroactive material on the second current collector.

18. The method of claim 12, wherein the applying of the first insulation material occurs by immersing the first terminal edge in a slurry bath and drying it to form the first insulation material and the applying of the second insulation material occurs by immersing the second terminal edge in a slurry bath and drying it to form the second insulation material.

19. The method of claim 12, wherein after the welding, further comprising applying a third insulation material over exposed surfaces of the weld nugget.

20. The method of claim 10, further comprising prior to the welding:
removing a portion of a first terminal edge of a first current collector to define the first electrically conductive tab;
removing a portion of a second terminal edge of a second current collector to define the second electrically conductive tab;
applying the first insulation material to the first electrically conductive tab; and
applying the second insulation material to the second electrically conductive tab.
